(19) United States
(12) Patent Application Publication
(10) Pub. No.: US 2026/0179868 A1
(43) Pub. Date: Jun. 25, 2026

(54) TRANSFORMER-BASED TRIGGER MECHANISM FOR CURRENT INTERRUPTION DEVICES AND CIRCUIT DESIGNS FOR SAME

(71) Applicant: Sensata Technologies, Inc., Attleboro, MA (US)

(72) Inventors: Fernanda Velasquez Ortega, Santa Barbara, CA (US); Samuel Naumowicz, Scottsdale, AZ (US); Cory Bousquet, Uxbridge, MA (US)

(73) Assignee: Sensata Technologies, Inc., Attleboro, MA (US)

(21) Appl. No.: 18/760,486

(22) PCT Filed: Jan. 31, 2023
(86) PCT No.: PCT/US2023/012041

§ 371 Date: Jul. 1, 2024

Related U.S. Application Data
(60) Provisional application No. 63/305,057, filed on Jan. 31, 2022.
(60) Provisional application No. 63/395,234, filed on Aug. 4, 2022.

(51) Int. Cl. H01H 71/12; H01H 39/00; H01H 85/02

(52) U.S. Cl. CPC H01H 71/125; H01H 39/006; H01H 85/0241; H01H 2039/008; H01H 2085/0266; H01H 2085/0291

(57) ABSTRACT

An improved circuit interruption system for interrupting a primary circuit includes a secondary circuit disposed in a magnetic field generated by current passing through the primary circuit. In response to a threshold change to the charge induced in the secondary circuit, a circuit interrupting device opens the primary circuit.

### CROSS-REFERENCE TO RELATED APPLICATIONS

This application claims the benefit of priority of International Application No. PCT/US2023/012041, filed Jan. 31, 2023, titled, “TRANSFORMER-BASED TRIGGER MECHANISM FOR CURRENT INTERRUPTION DEVICES AND CIRCUIT DESIGNS FOR SAME,” which claims priority to U.S. Provisional Application No. 63/305,057, filed Jan. 31, 2022, titled, “Transformer-based Trigger Mechanism for Current Interruption Devices,” and to U.S. Provisional Application No. 63/395,234, filed Aug. 4, 2022, titled “Transformer-based Trigger Mechanism for Current Interruption Devices and Circuit Designs for Same,” the entire disclosures of each of which are hereby incorporated by reference in their entirety.

### FIELD OF THE TECHNOLOGY

The subject disclosure relates to triggering mechanisms, and more particularly to transformer-based trigger mechanisms and transformer circuit designs for use with electrical devices.

### BACKGROUND OF TECHNOLOGY

Many electrical systems include devices that provide overcurrent protection. Such devices can prevent short circuits, overloading, and/or permanent damage to the electrical system and/or devices connected thereto. Fuses are one type of overcurrent protection device. Generally, fuses are configured to break a circuit, usually permanently, in response to an unacceptably high current through the circuit.

Some traditional fuses use thermal elements that melt when subjected to a specific current. While thermal fuses provide acceptable passive trigger functionality in some applications, thermal fuses are not without drawbacks. For instance, thermal fuses must generate significant heat to be effective, which may require the fuse to have an undesirably high electrical resistance. Moreover, thermal fuses experience thermal fatigue over their life, often leading to premature failure. Also, in some examples, thermal fuses may interrupt the flow of current too slowly. Because of these and other shortcomings, thermal fuses may not be preferred in some applications.

More recently, electro-mechanical fuses and fuses with pyrotechnic charges have been developed, especially for use in electrical vehicles. Such fuses may overcome some of the shortcomings of thermal fuses while providing overcurrent protection in vehicles to prevent device malfunction, minimize damage to the vehicle, and/or reduce the risk of electrical fires in the event of an overcurrent event. While these fuses provide benefits over conventional thermal fuses, such fuses can require complex and/or expensive components. There is a need in the art for improved systems and techniques for protecting electrical systems from overcurrent events or the like.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a circuit diagram of a circuit interruption system including a primary circuit and a second circuit arranged relative to the primary circuit to generate a magnetic flux, in accordance with aspects of this disclosure.

FIG. 2 is a perspective view of aspects of a circuit interruption system, in accordance with aspects of this disclosure.

FIG. 3 is a perspective view of aspects of an additional circuit interruption system, in accordance with aspects of this disclosure.

FIG. 4 is a perspective view of aspects of an additional circuit interruption system, in accordance with aspects of this disclosure.

FIG. 5 is a perspective view of aspects of an additional circuit interruption system, in accordance with aspects of this disclosure.

FIG. 6A is a perspective view of aspects of an additional circuit interruption system, in accordance with aspects of this disclosure.

FIG. 6B is a partial cross-section view, taken along the section line 6A-6A, of the system shown in FIG. 6A.

FIG. 7 includes visualizations of magnetic flux density relative to a bus bar, in accordance with aspects of this disclosure.

FIG. 8 shows an implementation of a circuit interruption system, in accordance with aspects of this disclosure.

FIG. 9 is a graph plotting induced voltage from current pulse for the circuit interruption system of FIG. 8, in accordance with aspects of this disclosure.

FIGS. 10-13 are examples of transformer circuits, in accordance with aspects of this disclosure.

FIG. 14 is a graphic demonstrating aspects of a Zener diode, in accordance with aspects of this disclosure.

FIGS. 15 and 16 are examples of transformer circuits including Zener diodes, in accordance with aspects of this disclosure.

FIG. 17 is an example of a transformer circuit include a voltage multiplier, in accordance with aspects of this disclosure.

FIG. 18 is a graphic demonstrating aspects of a voltage multiplier circuit, in accordance with aspects of this disclosure.

FIG. 19 is a graphic demonstrating aspects of a silicon controlled rectifier (SCR), in accordance with aspects of this disclosure.

FIGS. 20-25 are examples of transformer circuits including SCRs, in accordance with aspects of this disclosure.

FIGS. 26 and 27 are examples of additional transformer circuits, in accordance with aspects of this disclosure.

### DETAILED DESCRIPTION

The subject technology overcomes prior art problems associated with conventional fuses. For example, the systems and techniques described herein provide a fuse including a circuit disposed in a magnetic field generated by an electrical system subject to overcurrent conditions. The secondary (fuse) circuit is connected to an internal component, such as a pyrotechnic charge, that is detonated by the induced current and provides the energy to interrupt the current flow in the primary circuit. In examples, the systems and techniques described herein may overcome the shortcomings of traditional thermal fuses while using no moving parts, electronic sensors, or integrated circuits in the passive trigger mechanism. The systems and techniques disclosed herein may improve performance when compared to thermal fuses allowing solutions with lower electrical resistance and higher interruption speed. The systems and techniques disclosed herein may also reduce cost and/or improve reliability in comparison to existing thermal fuse alternatives.

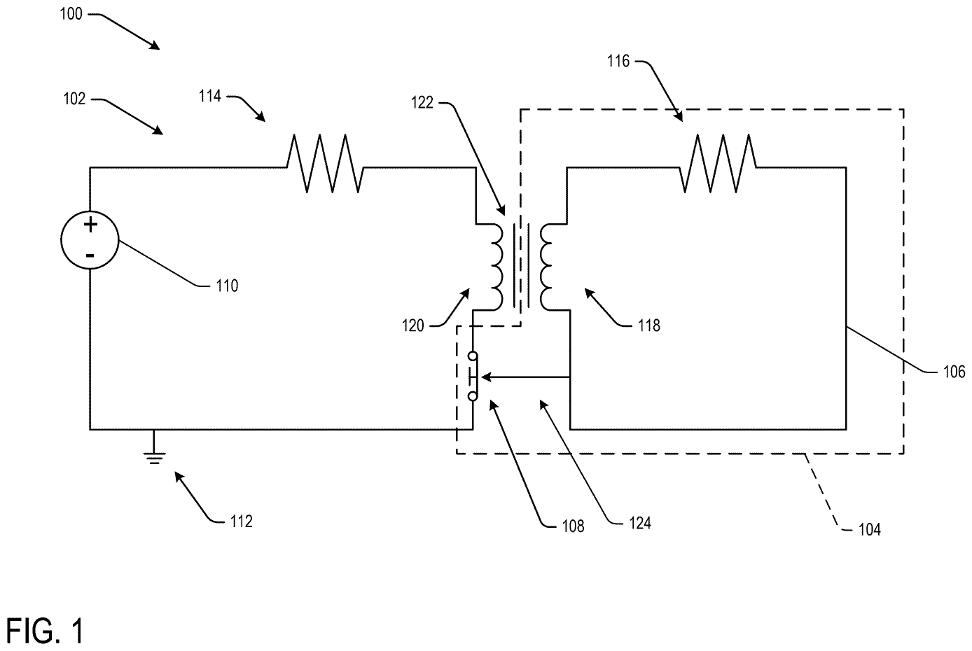

FIG. 1 is a schematic circuit diagram 100 representing aspects of this disclosure. Specifically, FIG. 1 shows a primary (first) circuit 102 and a circuit interruption system 104 associated with the primary circuit 102. The circuit interruption system 104 includes a secondary (second) circuit 106 and a circuit interruption device 108, as detailed further herein. The primary circuit 102 may generally represent an electrical system or current-carrying system with which the techniques of this disclosure are to be used. As illustrated, the primary circuit 102 includes a primary circuit voltage source 110, a primary circuit ground 112, and a primary circuit resistance 114. Without limitation, the primary circuit voltage source 110 can be a battery, generator, or other power source. The primary circuit ground 112 and/or the primary circuit resistance 114 may be associated with one or more loads, e.g., to be powered by the primary circuit 102. In some example implementations, the primary circuit 102 may be associated with an electric vehicle, in which the primary circuit 102 may be a power circuit connecting one or more rechargeable batteries, e.g., as the primary circuit voltage source 110, to one or more vehicle components, e.g., motors or the like. The primary circuit 102 is not limited to being associated with an electric vehicle.

FIG. 1 also illustrates the circuit interruption system 104 as being associated with the primary circuit 102. More specifically, the circuit interruption system 104 is coupled to the primary circuit 102 to break the primary circuit 102, e.g., in response to a current overload (a short circuit or the like). As illustrated, the circuit interruption system 104 includes the secondary circuit 106 and the circuit interruption device 108 in communication with the secondary circuit 106. The secondary circuit 106 also includes a secondary circuit resistance 116 and a secondary coil 118. The secondary coil 118 cooperates with a primary coil 120 associated with the primary circuit 102. As detailed further herein, the secondary coil 118 is disposed in a magnetic field generated at the primary coil 120 to create a magnetic flux link 122. In examples, the secondary coil 118 and the primary coil 120 may act like a transformer, e.g., by inducing a current in the second coil 118 using a magnetic field induced at the primary coil 120, e.g., from current passing through the primary coil 120. Specifically, the circuit interruption system 104 also includes the circuit interrupting device 108 positioned to interrupt the primary circuit 102 in response to a signal 124 that indicates that a threshold current has been exceeded in the primary circuit 102, as described further herein.

In operation, the secondary circuit 106 is magnetically coupled to the primary circuit 102 via the secondary coil 118. For example, the secondary coil 118, or some other portion of the secondary circuit 106, is disposed in the magnetic field generated by current passing through the primary coil 120 associated with the primary circuit 102. In examples, the primary circuit 102 may include a high voltage bus bar as the primary coil 120. Current passing through the bus bar will generate a magnetic field. The secondary coil 118 may be placed in the magnetic field such that the magnetic field induces a current in the secondary circuit 106. The current induced in the secondary circuit 106 may be a relatively low voltage circuit, e.g., compared to the relatively higher voltage primary circuit. The strength of the magnetic field is directly related to the current in the primary circuit 102 and characteristics of the charge through the secondary circuit 106 are directly related to the strength of the magnetic field. Thus, when the current increases in the primary circuit 102, the magnetic field will strengthen, causing the current through secondary circuit 106 to increase. Aspects of this disclosure include using the increased current in the second circuit to identify overcurrent conditions or other anomalies in the primary circuit 102, e.g., caused by a short, a surge, or other (e.g., potentially-hazardous) conditions. In examples, when the current (or voltage) in the secondary circuit meets or exceeds a threshold current (or voltage), the circuit interrupting device 108 is signaled, via the signal 124, to open the primary circuit 102.

As will be appreciated from this disclosure, the primary coil 120 may comprise a first inductor and the secondary coil 118 may comprise a second inductor. Together, the first inductor and the second inductor form an inductor pair. The inductor pair may function in a manner similar to a transformer, e.g., with current in the primary coil (e.g., the first inductor) generating a magnetic field that induces a voltage in the secondary coil (e.g., the second inductor). Aspects of this disclosure use changes in the induced voltage to identify changes in the primary current (through the primary coil), which may signal an unsafe operating condition.

According to aspects of this disclosure, the circuit interruption system 104 may be embodied as a fuse or similar electrical component that is coupled to the primary circuit 102 to provide overcurrent protection to the primary circuit 102 as detailed herein. Although not illustrated, aspects of the circuit interruption system 104 can be contained in a housing and/or may take other forms for coupling to the primary circuit 102. In examples, the circuit interrupting device 108 can include a pyrotechnic device, e.g., activated to physically sever the primary circuit 102. However, the circuit interrupting device 108 is not limited to pyrotechnic devices. For example, and without limitation, the circuit interrupting device 108 may include any mechanical, electrical, chemical, electro-mechanical, electro-chemical, and/or other device that can interrupt the flow of electricity through the primary circuit 102.

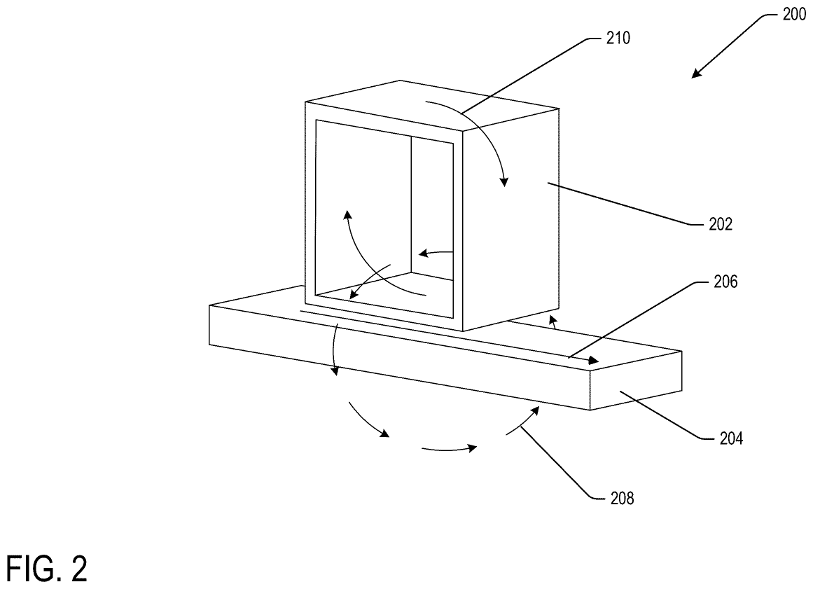

FIGS. 2-6B show example implementations of interfaces between the primary circuit 102 and the secondary circuit 106. In these examples, aspects of the primary circuit 102 and of the circuit interrupting system 104 are omitted for clarity.

FIG. 2 shows additional details of a portion of a circuit interrupting system 200, which may be the circuit interrupting system 104 discussed above. Specifically, FIG. 2 shows a secondary coil 202, which may be the secondary coil 118, arranged proximate a primary coil 204, which may be the primary coil 120. The secondary coil 202 is part of a secondary, e.g., low-voltage circuit, like the secondary circuit 106, and the primary coil 204 is part of a primary, e.g., high-voltage circuit, like the primary circuit 102. In the illustrated example, the primary coil 204 comprises a bus bar or other conductive material through which a high-voltage current passes in an electrical system. In this example, the secondary coil 202 has an open or air core. In examples, the secondary coil 202 can include a plurality of conductive windings disposed about the air core. Although the secondary coil 202 is illustrated as being substantially rectangular in the example of FIG. 2, the secondary coil 202 can take other shapes or configurations in which an induced current is capable of being created, according to the techniques detailed herein.

FIG. 2 also illustrates a primary current 206 passing through the primary coil 204. The primary current 206 may be a high voltage DC current. The primary current 206 generates a magnetic flux 208 about the primary coil 204. In the example, the magnetic flux 208 is embodied as a magnetic flux path generated by the current, e.g., the primary current 206, passing through the primary coil 204. The secondary coil 202 is disposed proximate the primary coil 204 in the magnetic flux path. The magnetic flux 208 generates an induced current 210 in the secondary coil 202, as also shown in FIG. 2. As will be appreciated, and as discussed above, as the primary current 206 in FIG. 2 changes (e.g., increases due to an overload condition), characteristics of the magnetic flux 208, and thus the induced current 210 in the secondary coil 202, will change. These changes may be used to trigger a circuit interruption device, as described above.

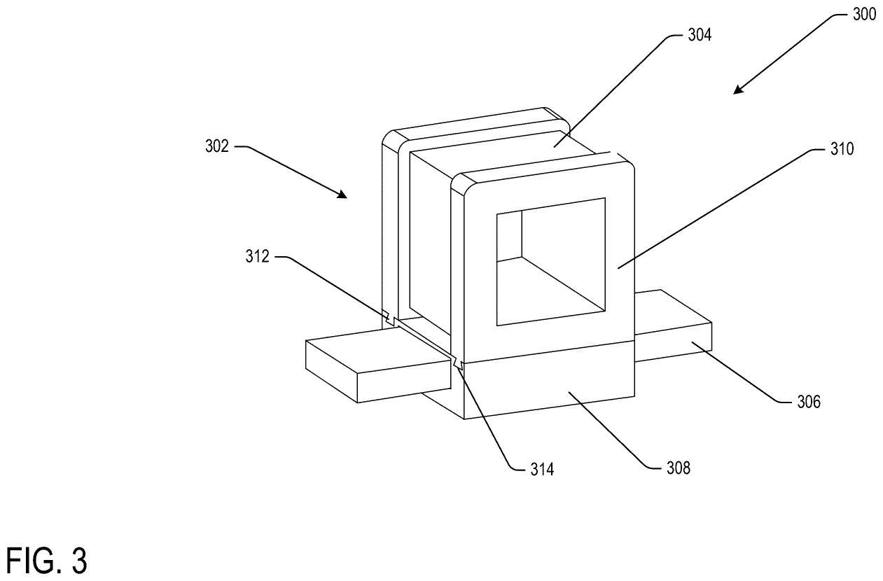

FIG. 3 shows aspects of another circuit interrupting system 300, which is a variation of the arrangement of FIG. 2. Specifically, FIG. 3 includes an insulator 302 disposed to position a secondary coil 304, which may the secondary coil 118 and/or the secondary coil 202, proximate a primary coil 306, which may be the primary coil 120 and/or the primary coil 204. The secondary coil 304 is part of a secondary, e.g., low-voltage circuit, like the secondary circuit 106, and the primary coil 306 is part of a primary, e.g., high-voltage circuit, like the primary circuit 102. In the illustrated example, the primary coil 306 comprises a bus bar or other conductive material through which a high-voltage current passes in an electrical system. The coils 304, 306 of FIG. 3 operate in substantially the same manner as the coils 202, 204 discussed above. For instance, a primary current passing through the primary coil 306 generates a magnetic flux about the primary coil. The magnetic flux induces a current (and/or voltage) in the secondary coil 304 when at least a portion of the secondary coil 304 is disposed in the magnetic flux.

Unlike the example of FIG. 2, the system 300 also includes the insulator 302. In the illustrated example, the insulator 302 includes a first portion 308 and a second portion 310. The first portion 308 is configured for coupling to the primary coil 306. In the illustrated example, the first portion 308 defines an opening or receptacle configured to accept the primary coil 306. In some examples, when the primary coil 306 is a bus bar, as illustrated in FIG. 3, the first portion 308 of the insulator 302 may comprise a sleeve configured for being received on the primary coil 306. The second portion 310 of the insulator 302 is configured to carry the secondary coil 304. For example, the second portion 310 of the insulator 302 may be embodied as a bobbin about which the secondary coil 304 is wound. For instance, the secondary coil 304 can include a plurality of conductive windings wound about the second portion 310 of the insulator 302. Although the secondary coil 304 is illustrated as being substantially rectangular in the example of FIG. 3, the secondary coil 304 can take other shapes or configurations in which an induced current is capable of being created, according to the techniques detailed herein.

In the example of FIG. 3, the first portion 308 and the second portion 310 of the insulator 302 may be separate components that are selectively coupled. For example, in the illustrated example, the second portion 310 includes one or more tabs 312 configured to be received in corresponding receptacles or grooves 314 formed in the first portion 308 of the insulator 302. For example, the first portion 308 and the second portion 310 may be slidably engaged via the tabs 312 and the grooves 314. For example, the tabs 312 may comprise rails having a longitudinal extend generally along a longitudinal direction of the primary coil 306, with the grooves 314 being configured to slide onto the rails. Although the tabs 312 and grooves 314 are shown in the example of FIG. 3, other coupling components may be used to couple the first portion 308 to the second portion 310. For example, forming the insulator 302 as two (or more pieces) may add in manufacturing and/or assembly of the system 300. For instance, wrapping the secondary coil 304 around the second portion 310 may be easier when the second portion 310 is separate from the first portion 308. Moreover, coupling the first portion 308 to the primary coil 304 may be easier when the first portion 308 is separate from the second portion 310. In examples, the insulator 302 may be made of a material that is not conductive, e.g., so as to have little to no impact on the current passing through the primary coil 306 or the secondary coil 304 and/or on the magnetic field. For example, the insulator 302 may be made of a polymer, such as a molded polymer.

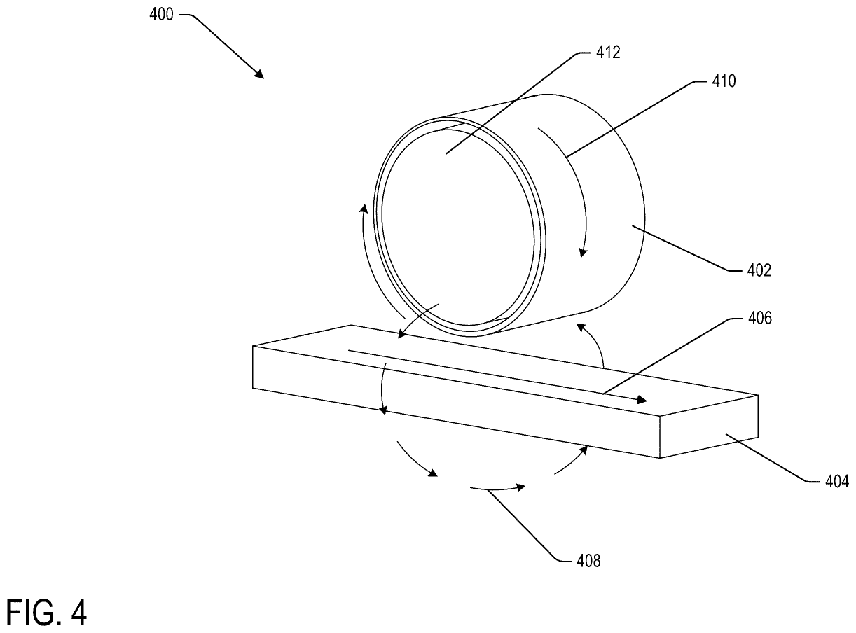

FIG. 4 shows aspects of another circuit interrupting system 400, which is another variation of the arrangement of FIG. 2. Specifically, the system 400 includes a secondary coil 402, e.g., corresponding to the secondary coil 202, and a primary coil 404, e.g., corresponding to the primary coil 204. The secondary coil 402 is illustrated as a cylindrical coil, e.g., which may comprise a plurality of substantially circular windings, instead of the square or rectangular windings of FIG. 2. Of course, the shape of the coils 402, 404 are for example only; other shapes, including those discussed in different examples detailed herein may be used.

As with the previous examples, a primary current 406 passing through the primary coil 404 induces a magnetic field 408, which in turn induces a secondary current 410 in the secondary coil 402. In the example of FIG. 4, the secondary coil 402 is disposed, e.g., wrapped, around a core 412. For example, the core 412 may be a ferromagnetic core around which the secondary coil is arranged, e.g., wrapped. As will be appreciated, the core 412 shown in FIG. 4 may increase and/or direct the magnetic flux 408 generated by the primary current 406 passing through the primary coil 404. In this example, the ferromagnetic core is a partial ferromagnetic core in that it is placed only in a portion of the magnetic field, e.g., in a position adjacent to the primary coil. The ferromagnetic core may be formed of iron or a ferrous alloy. Other materials that may facilitate transmission of the magnetic flux 408 may also be used.

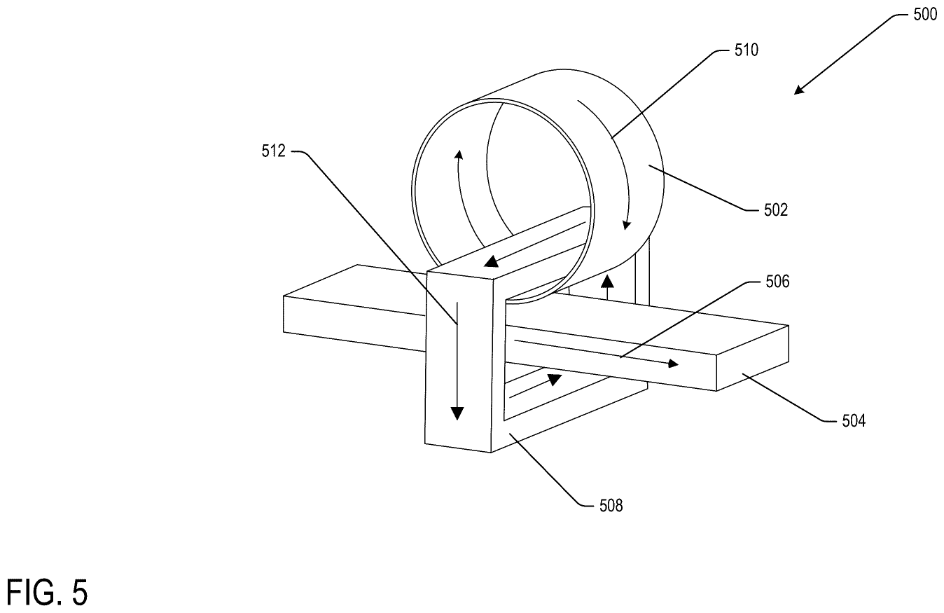

FIG. 5 shows aspects of yet another circuit interrupting system 500, which is another variation of the arrangement discussed above. Specifically, FIG. 5 includes a secondary coil 502, substantially the same as the secondary coil 402 and a primary coil 504, substantially the same as the primary coil 404. As with other examples described herein, a primary current 506 passing through the primary coil 404 generates a magnetic field and the secondary coil 402 is disposed in the magnetic field. A current (or voltage) is induced in the secondary coil 402 in response to a change in the magnetic field resulting from a change in the primary current 406.

The example of FIG. 5 also includes a ferromagnetic core 512. As with the example of FIG. 4, and other examples herein, the ferromagnetic core 512 increases and/or otherwise interacts with the magnetic field to define a magnetic flux path 514 through the ferromagnetic core 512. In the example of FIG. 5, the ferromagnetic core 512 may comprise a winding, and is disposed to circumscribe a portion of the primary coil 506. By encircling the primary coil 506, the ferromagnetic core may be disposed to increase the magnetic flux throughout substantially all of the magnetic field, e.g., unlike the example of FIG. 4 in which the core 412 is disposed only on a side of the primary coil 506. The ferromagnetic core 512 defines the magnetic flux path 514, and the secondary coil 502 is disposed about a portion of the ferromagnetic core 512. For example, the secondary coil 502 may be one or more windings about a portion of the ferromagnetic core 512. In the example of FIG. 5, the ferromagnetic core 512 is formed as a substantially rectangular core 512 including four legs. The secondary coil 502 is illustrated as a winding on one of the legs. In other examples, however, the ferromagnetic core 512 and/or the secondary coil 502 may be differently shaped and/or positioned.

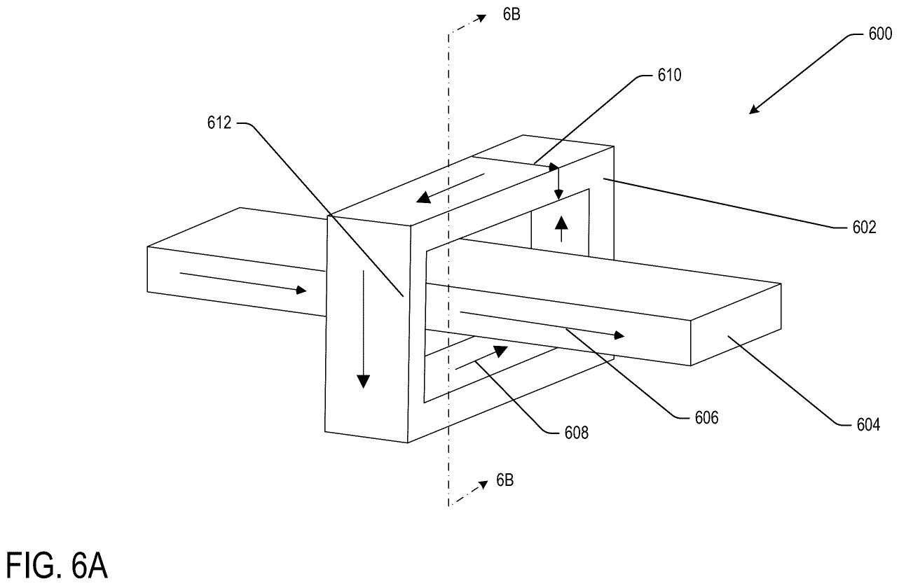

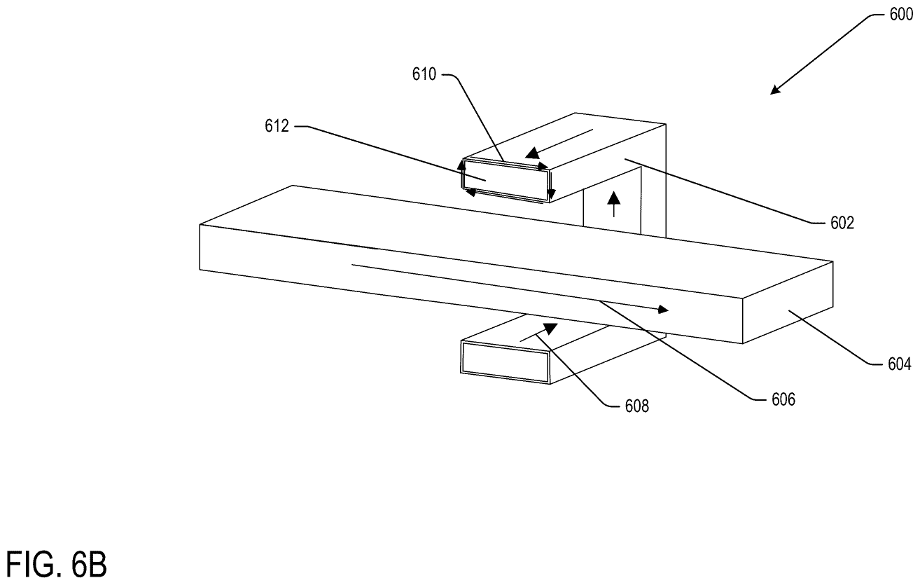

FIGS. 6A and 6B show aspects of yet another circuit interrupting system 600. In this arrangement, a secondary coil 602 is disposed around a primary coil 604. The secondary coil 602 and/or the primary coil 604 may correspond in function and/or composition to any of the secondary and/or primary coils described herein. In operation, a primary current 606 in the primary coil 604 generates a magnetic flux 608 that induces a secondary current 610 in the secondary coil 602. In this example, the secondary coil 602 can include one or more windings disposed such that the secondary current flows as shown in FIG. 6. For instance, the windings comprising the secondary coil 602 can comprise a number of smaller windings arranged in a loop that is the secondary coil 602 shown in FIG. 6. In this example, the secondary coil 602 circumscribes the primary coil 604, but each individual winding is disposed generally as demonstrated by the arrows illustrating the secondary current flow 610. Stated differently, the windings making up the secondary coil 602 may not each circumscribe primary coil 604. FIG. 6A also shows directions of the primary current (in the primary circuit or primary coil), the magnetic flux path, and the induced current. With the arrangement of FIG. 6A, unlike other previous examples, substantially all of the secondary coil 602 is disposed directly in the magnetic field generated by the primary current 606.

FIG. 6B is a partial cross-section of FIG. 6A, with the secondary coil 602 sectioned along the section line 6B-6B in FIG. 6A. In FIG. 6B the same reference numerals reference the same features. FIG. 6B shows that the system 600 may include a ferromagnetic core 612 around which the secondary coil 602 is disposed, e.g., wrapped. The ferromagnetic core 612 may be similar to or the same as the ferromagnetic core 512 shown in FIG. 5 and discussed above. FIG. 6B also better shows the direction of the secondary current 610 induced in the secondary coil 602, which may also correspond to the direction of windings used to make the secondary coil 602.

Although omitted for clarity, any of the systems 200, 300, 400, 500, 600 can include one or more of a housing and/or other components for retaining the coils and/or cores in the illustrated arrangements. As will be appreciated, when used, the ferromagnetic core may enhance and/or align the magnetic field, e.g., to provide for a stronger induced secondary current when compared to examples in which the core is not provided. Also omitted from the illustrated systems are additional components of the circuit diagram 100 shown in FIG. 1, such as a source and/or load associated with the primary coil, the circuit interruption device, and the secondary circuit resistor. As will be appreciated, the secondary coil may include a number of windings formed of a conductive wire, and the wire may be connected to other components configured to break the primary circuit in response to a predetermined change in the current flowing through the secondary circuit.

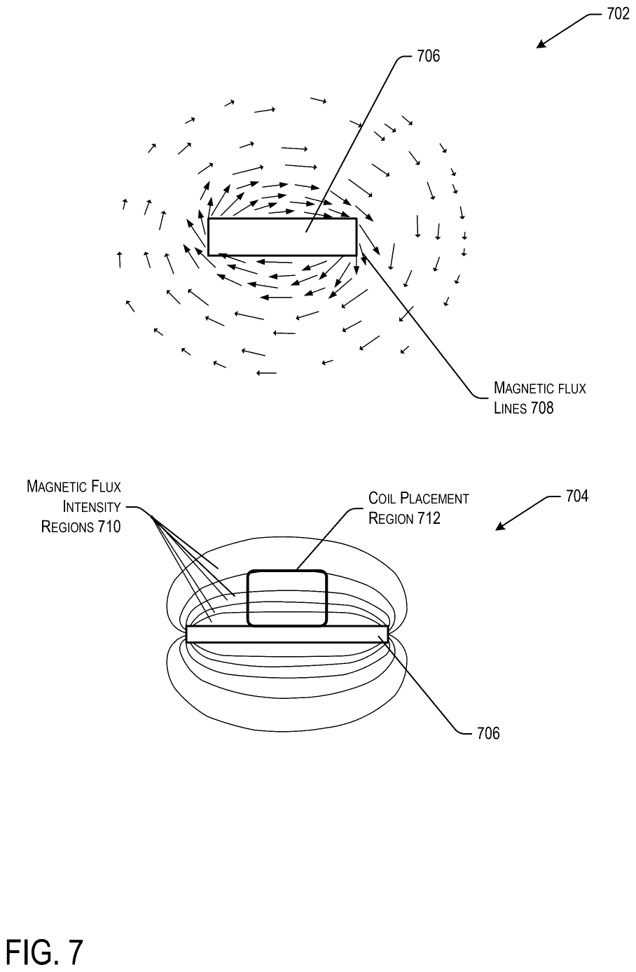

FIG. 7 includes a first representation 702 and a second representation 704 of magnetic flux density relative to a bus bar 706, which may be the primary coil shown in any of FIGS. 2-6B, e.g., associated with the primary circuit. Specifically, the first representation 702 is a front view of the bus bar, in which current in the bar 706 travels into the page. In the first representation 702, the arrows 708 represent the direction and magnitude of the magnetic flux density. For example, the longer and/or heavier the arrow 708, the higher the magnetic flux density. The shorter and/or lighter the arrow 708, the lower the magnetic flux density. As will be appreciated from the first representation, the magnetic flux is higher proximate edges of the bar 706 and lower farther from the bar 706. In examples, the magnetic flux proximate the edges of the bar 706 may be on the order of about 0.08 Tesla and lower at distances from the bar 706.

The second representation 704 is a side view of the bus bar 706, in which current travels from left to right (or right to left) relative to the page. FIG. 7B shows a plurality of regions or bands 710 proximate the bus bar 706. In the example, five regions 710 are shown above the bar 706 and a corresponding five regions are shown below the bar 706. Each of the regions 710 represents a magnetic flux density, which as shown in the first representation 702 increases closer to the bus bar 706. For example, the region of the regions 710 closest to the bar 706 may correspond to a magnetic flux density of from about 0.055 to about 0.07 Tesla. The magnetic flux density decreases at regions 710 farther from the bus bar 706. For example, the second region of the regions 710 from the bar 706 may correspond to a flux density of from about 0.35 to about 0.055. Of course, the regions are for illustration only and the value of the magnetic flux may vary based on a number of factors.

As also illustrated, the magnetic flux density may be stronger (and/or be stronger at distances farther from the surface of the bus bar 706) proximate the (longitudinal) center of the bus bar 706. The second representation 704 also illustrates a coil placement region 712. The region 712 may represent a preferred location for placement of the secondary coils and/or the ferromagnetic cores relative to a primary coil, as described herein. For example, the magnetic flux density may be greatest in the region 712 (e.g., the magnetic field is the strongest in the region 712). In examples, the region 712 may have a minimum flux density of more than about 0.02 Tesla, although such is not required.

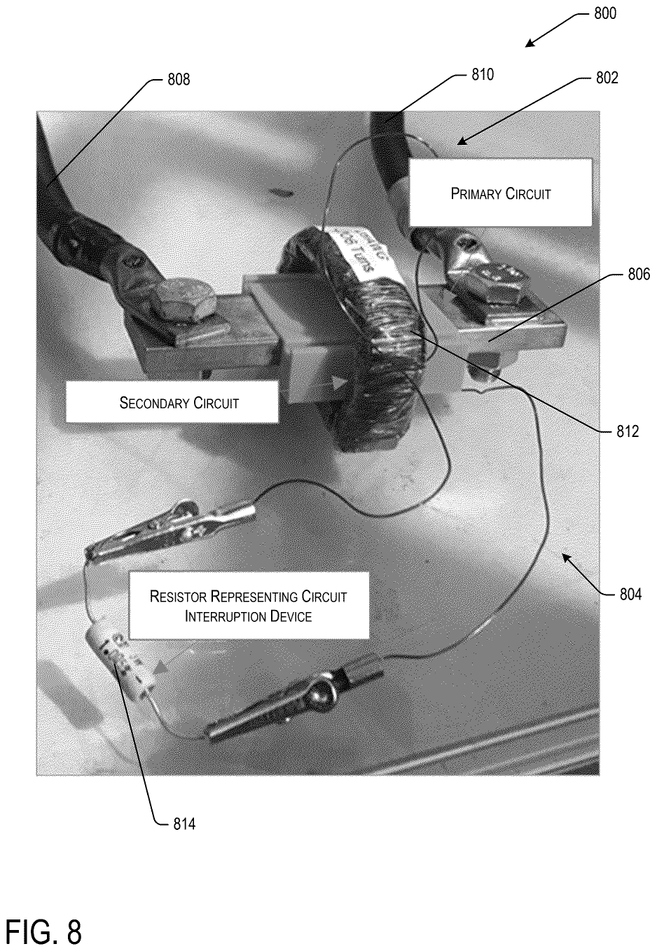

FIG. 8 is a schematic representation 800 of an experimental implementation of aspects of the systems and techniques described herein. Specifically, FIG. 8 includes aspects of a primary circuit 802, e.g., which may correspond to the primary circuit 102 discussed above, and a secondary circuit 804, e.g., which may correspond to the secondary circuity 104 discussed above. In the example, the primary circuit 802 includes a bus bar 806 connected to a first electrical lead 808 and a second electrical lead 810. In examples, one of the leads 808, 810 may be connected to a high voltage power source and the other of the leads 808, 810 may be connected to a load to be powered by the power source. In the illustrated experimental implementation, the bus bar 806 may be a copper bus bar or may be made of some other highly conductive material. The leads 808, 810 are shown as connected to the bus bar via bolts, although other connections are contemplated; the disclosure is not limited to the shown attachment techniques.

The secondary circuit 804 includes a coil 812 disposed around the bus bar 806. As shown, the coil 812 includes a wire, e.g., a copper wire, forming a number of turns or windings that together form a loop that circumscribes the bus bar 806. Ends of the wire forming the coil are connected to a resistor 814. The resistor 814 is coupled to the secondary circuit for testing purposes. For example, the resistor 814 may be representative of a circuit interruption device, like that illustrated in FIG. 1 and discussed above. As also illustrated in FIG. 8, an insulator 816 is provided between the coil 812 and the bus bar 806. The insulator may be a substantially non-conductive material. As will be appreciated, the arrangement of FIG. 8 may correspond to the arrangement of FIG. 6A, discussed above. Specifically, the bus bar 806 may correspond to the primary coil 604, and the coil 812 may correspond to the secondary coil 602. Although not visible in FIG. 8, the coil 812 may wound around a ferromagnetic core, e.g., as in the example of FIG. 6B.

The arrangement of FIG. 8 operates generally in the manner described above. Specifically, a high voltage current, e.g., a primary current, passes through the primary circuit 802. A magnetic field is created around the bus bar (generally as shown in the representations 702, 704 of FIG. 7). When the voltage in the primary circuit 802 changes, the magnetic field changes, inducing a current in the coil 812. The induced current can be used as a signal to indicate a change in the high voltage current. For example, when the change in high voltage current is the result of a short circuit, surge, or other overcurrent event, the signal can be used to sever the primary circuit, e.g., by breaking the primary circuit 802.

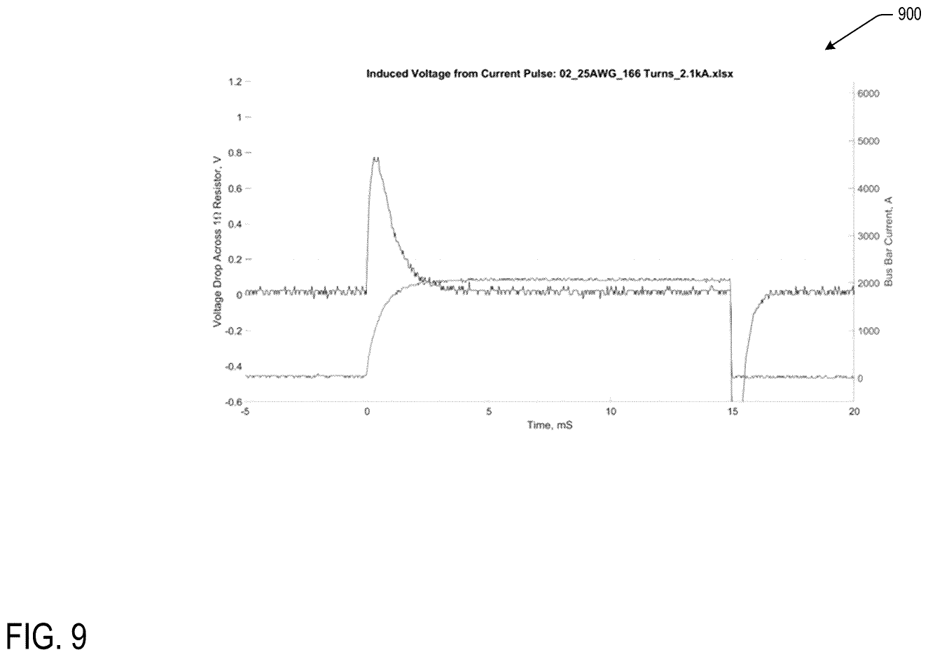

FIG. 9 is a graph 900 showing testing conducted on the implementation 800 shown in FIG. 8. Specifically, FIG. 9 shows voltage drop across the resistor 814 in the implementation 800 and the current through the bus bar 806. The voltage signal is induced by the secondary circuit 804 during a 2.1 kA short circuit in the primary circuit 802. As illustrated, the increase in current through the bus bar 806 causes a near instantaneous voltage increase of about 0.75 V across the resistor 814. In practice, a circuit interruption device, e.g., the circuit interruption device 108 discussed above, may be positioned in place of the resistor 814, with the induced current causing trigger of the circuit interruption device, according to a predetermined change in voltage.

According to aspects described in connection with FIGS. 1-9, aspects of this disclosure relate to using a magnetic field generated by a primary circuit to induce a current in a secondary circuit, e.g., via a coil and/or a ferromagnetic coil disposed in the magnetic field. In examples, the current induced in the secondary circuit can be used as a signal to break or disrupt the primary circuit, e.g., in the event of an overcurrent condition in the primary circuit. Additional aspects described below particularly relate to implementations of the second circuit.

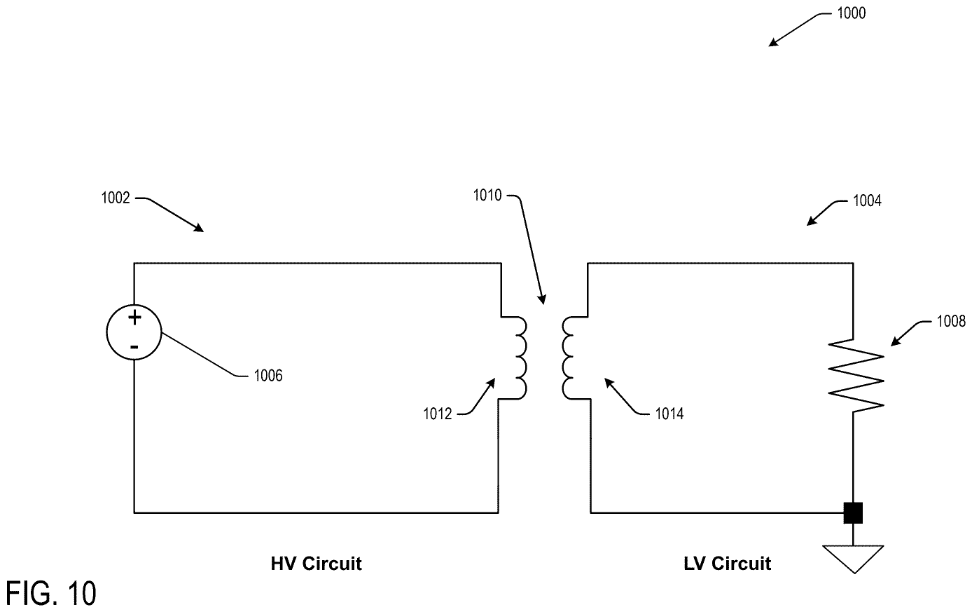

FIG. 10 is a circuit diagram showing a transformer circuit 1000, which may be the circuit of FIG. 1 and/or may be representative of the various arrangements of FIGS. 2-8. Specifically, FIG. 10 illustrates a primary circuit 1002, e.g., a high-voltage circuit, which may correspond to the primary circuit 102, and a secondary circuit 1004, e.g., a low-voltage circuit, which may correspond to the secondary circuit 106. The primary circuit 1002 includes a current source 1006, which may be a high-voltage current source for the high-voltage (HV) circuit.

The secondary circuit 1004 includes a resistor 1008, which may be a load. For example, the resistor 1008 may be the circuit-interrupting device described herein. Without limitation, the resistor 1008 may be a pyrotechnic or pyro device. In some examples, the resistor 1008 may represent any other load. When the resistor 1008 represents a pyro device, the pyro device may have a component that interrupts the primary circuit 1002. In some instances, the pyro device may directly interrupt the primary circuit 1002 circuit via fracturing. The pyro device may also (or alternatively) move a component that interrupts the primary circuit 1002. In examples, the pyro device may also move a component connected to a movable contact that connects the primary circuit 1002. Removal of this movable contact will interrupt the primary circuit 1002. Of course, these are examples, and the pyro device, in other examples, may otherwise interrupt the primary circuit 1002, e.g., via a fuse or other arrangement.

As also shown in FIG. 10, the transformer circuit includes an inductor pair 1010. For example, the primary circuit 1002 includes a first inductor 1012 and the secondary circuit 1004 includes a second inductor 1014. The first inductor 1012 may correspond to the primary coils discussed above and the second inductor 1014 may correspond to the secondary coils discussed above. Without limitation, the first inductor 1012 may be an inductor including a high voltage connection, e.g., a bus bar or a cable. The second inductor may be an inductor including multiple windings of conductive wiring, e.g., as a coil. The winding may be disposed about or otherwise associated with a core, according to different example aspects detailed above. In examples, the inductor pair 1010 acts as a transformer that generates voltage the secondary circuit 1004. The induced voltage is dependent on the magnitude of the current source 1006.

The circuit 1000 may be substantially the same as the circuit 100 discussed above, with the secondary circuit 1002 representing the circuit interruption system 104. In some instances, the transformer circuit 1000 may be suitable for disrupting the high voltage circuit in response to a surge in current, e.g., from the current source 1006. For instance, the surge in current in the primary circuit 1002 can cause a signal to the resistor 1008, which may be a circuit interruption device. In the circuit 1000, the change in current or voltage in the secondary circuit may lead directly to breaking the primary circuit 1002. Aspects of this disclosure also provide for additional circuit designs, including intermediate circuits associated with the secondary circuit 1004, e.g., connecting the second inductor 1014 and the resistor 1008 (the load). Such intermediate circuits may provide additional functionality. For instance, the transformer circuit 1000, while straightforward and functional, has limited tunability. Moreover, the transformer circuit 1000 may have reduced protection against pyro aging.

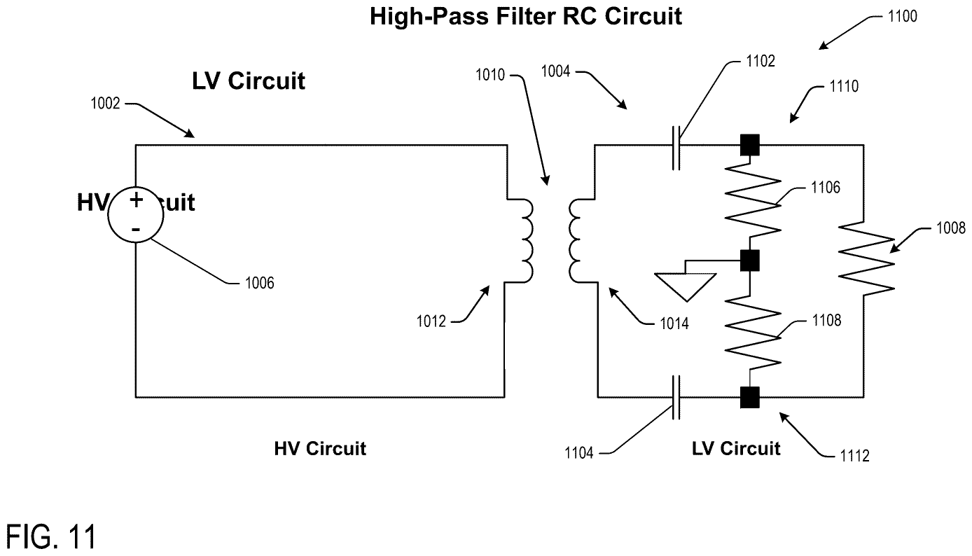

FIG. 11 shows a transformer circuit 1100 according to example implementations of this disclosure. In FIG. 11, reference numerals introduced in the discussion of FIG. 10 are used to designate the same components, e.g., including the primary circuit 1002 and the secondary circuit 1004. The transformer circuit 1000, e.g., shown in FIG. 10 and discussed above, may act as a basic filter, e.g., filtering out low frequency, e.g., low DI/DT, signals. However, the transformer circuit 1100 includes resistors and capacitors that provide additional filtering in the low-voltage circuit. Specifically, FIG. 11 illustrates a first capacitor 1102 and a second capacitor 1104, as well as a first resistor 1106 and a second resistor 1108 (e.g., in addition to the resistor 1108 representing a load). The resistors 1106, 1108 and capacitors 1102, 1104 form RC pairs disposed between the secondary inductor 1014 and the resistor (load) 1008. Specifically, FIG. 11 shows a first RC pair 1110 formed by the first resistor 1106 and the first capacitor 1102 and a second RC pair 1112 formed by the second resistor 1108 and the second capacitor 1104. Based on their configuration(s), the RC pairs 1110, 1112 may filter low-and/or high-frequency noise.

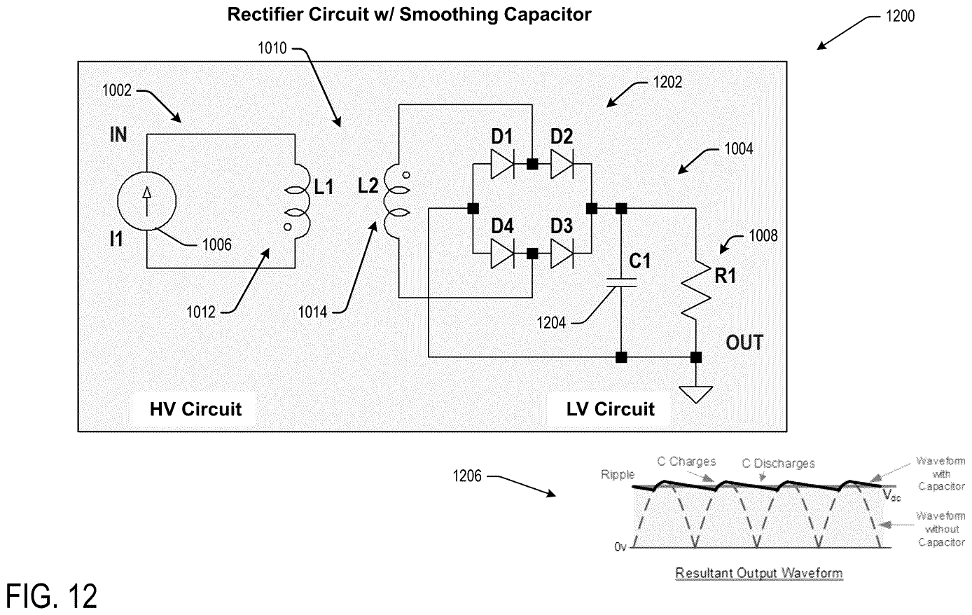

FIG. 12 shows an additional transformer circuit 1200 according to example implementations of this disclosure. In FIG. 12, reference numerals introduced in the discussion of FIG. 10 are used to designate the same components, e.g., including the primary circuit 1002 and the secondary circuit 1004. The transformer circuit 1200 includes a rectified charging circuit. The transformer output is bidirectional by nature. In more detail, the transformer circuit 1200 includes a diode bridge 1202 to rectify the output signal (e.g., to convert the signal from AC to DC). Specifically, the transformer circuit 1200 is illustrated as including a first diode D1, a second diode D2, a third diode D3, and a fourth diode D4 arranged as a bridge rectifier circuit, e.g., the diode bridge 1202. In examples, and as illustrated in FIG. 12, the transformer circuit 1200 can also include a capacitor 1204 between the diode bridge 1202 and the resistor (load) 1008. The addition of the capacitor 1204 may create a steadier output over time, e.g., as illustrated by the resultant output waveform 1206 included in FIG. 12.

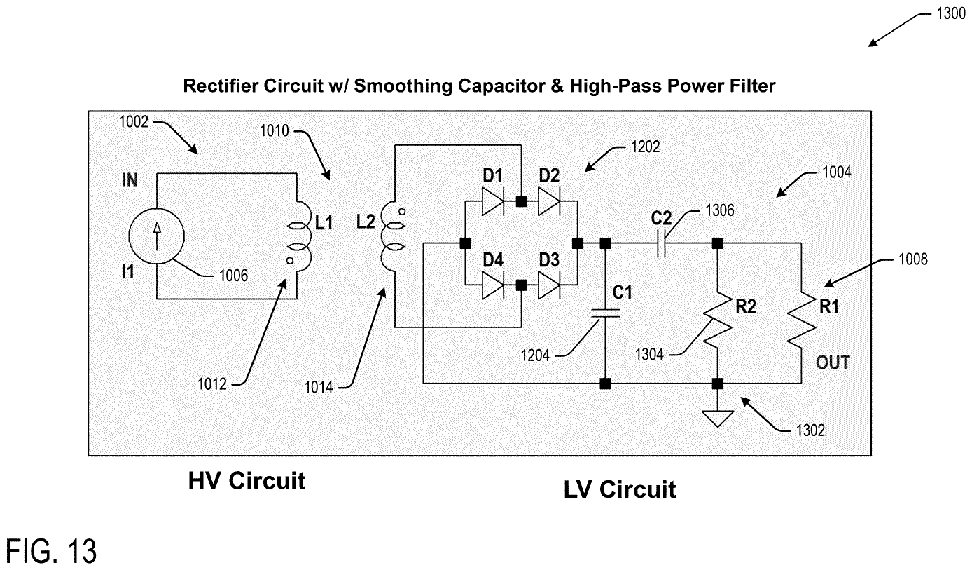

Combinations of aspects of the circuits described above also are contemplated. For example, FIG. 13 shows a transformer circuit 1300 that includes both a rectified charging circuit, as in the transformer circuit 1200 and filtering components, e.g., as in the transformer circuit 1100. More specifically, the transformer circuit 1300 includes the rectifier bridge 1202 (including the diodes D1-D4) and the optional smoothing capacitor 1204, as well as an RC pair 1302, e.g., a resistor 1304 and a capacitor 1306. In the examples, the RC pair 1302 is disposed between the rectifier bridge 1202 and the resistor (load) 1008 (e.g., the pyro device). In this example, the rectifier bridge 1202 and the smoothing capacitor 1204 help steady the transformer output, generally as discussed above. The RC pair 1302 acts as a filter to further isolate the load 1008 from noise. Although only a single RC pair 1302 is illustrated in FIG. 13, in other examples multiple pairs may be provided, e.g., as in the transformer circuit 1100 discussed above.

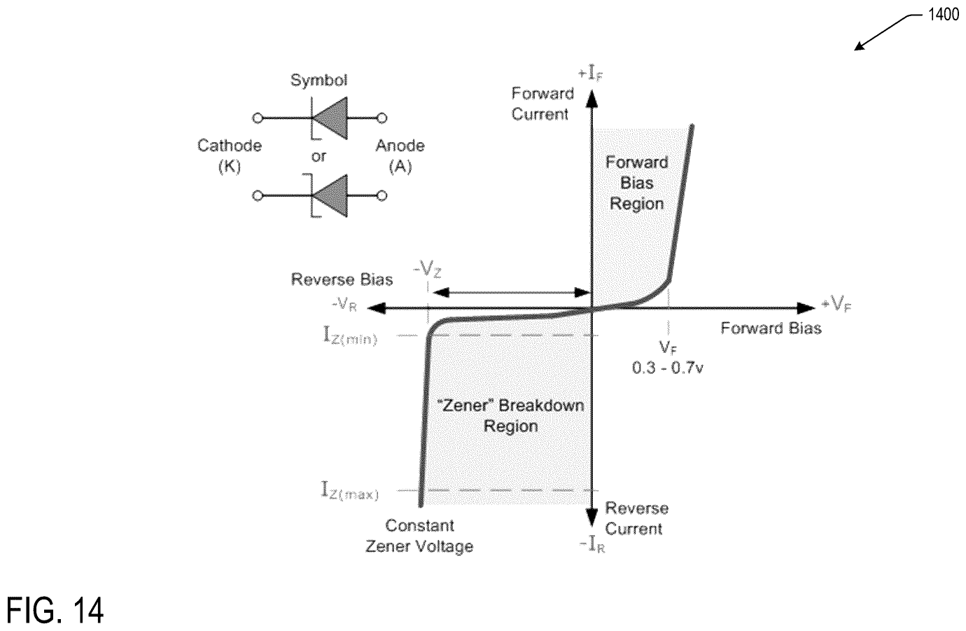

Additional circuit designs also are contemplated. For example, some aspects of this disclosure can include Zener, or breakdown, diodes. Zener diodes are diodes with a specific breakdown voltage. For examples, the breakdown voltage may be a relatively low breakdown voltage. The Zener diode will begin to conduct in a reverse bias once the necessary breakdown voltage, or “Zener voltage,” is applied. FIG. 14 includes a graphic 1400 showing the operation of Zener diodes.

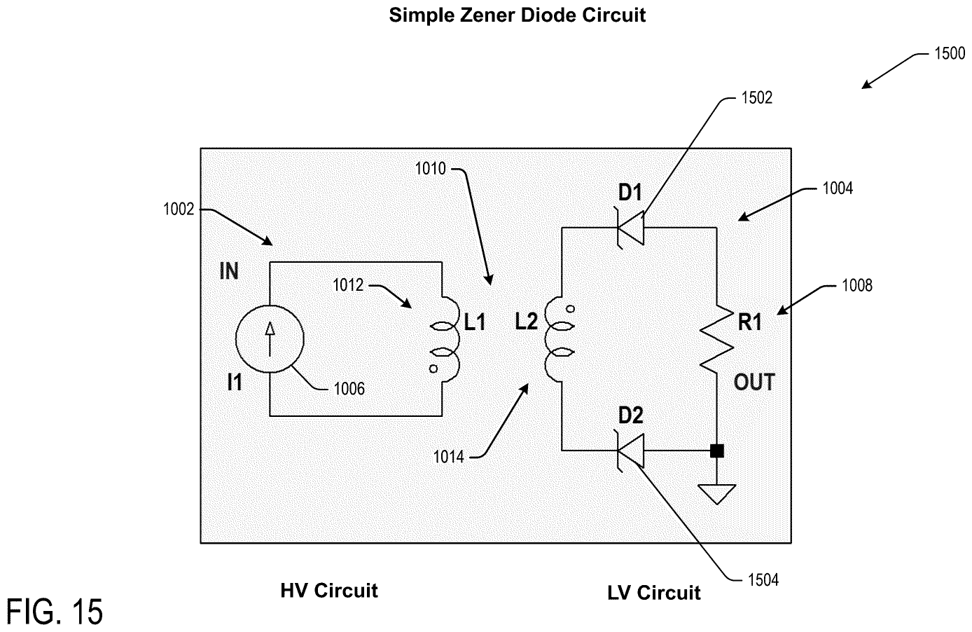

FIG. 15 shows an example transformer circuit 1500. In FIG. 15, reference numerals introduced in the discussion of FIG. 10 are used to designate the same components, e.g., including the primary circuit 1002 and the secondary circuit 1004. The circuit 1500 includes a first Zener diode 1502 and a second Zener diode 1504 between the second inductor 1014 and the load 1008 (e.g., the pyro device). In this example, the Zener diodes provide some pyro aging protection to a simple transformer-pyro circuit, e.g., like the transformer circuit 1000. In the transformer circuit 1500, the transformer will fully connect to the pyro device, e.g., the resistor (load) 1008, only when the inductor pair 1010 induces a voltage greater than the Zener voltage associated with the Zener diodes 1502, 1504.

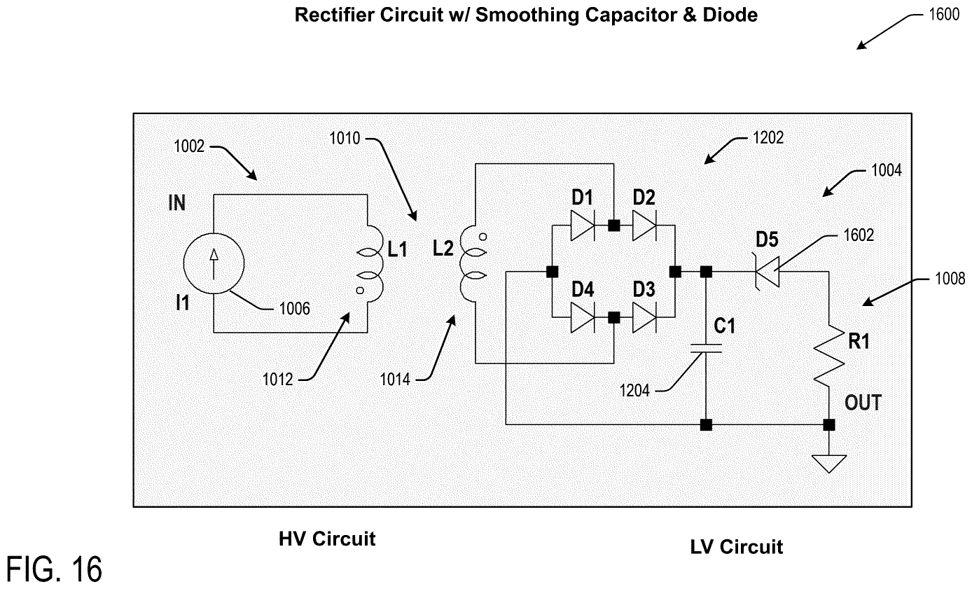

Zener diodes can also be used in combination with other circuit features detailed herein. For example, FIG. 16 shows an example transformer circuit 1600. In FIG. 16, reference numerals introduced in the discussion of FIGS. 10-15 are used to designate the same components, e.g., including the primary circuit 1002 and the secondary circuit 1004. The circuit 1600 includes a rectifier circuit, e.g., including the diode bridge 1202 and the optional smoothing capacitor 1204, e.g., as in the transformer circuit 1200 detailed above, as well as a Zener diode 1602. In the transformer circuit 1600, only the single Zener diode 1602 may be required for pyro protection, although more diodes may be included in other implementations.

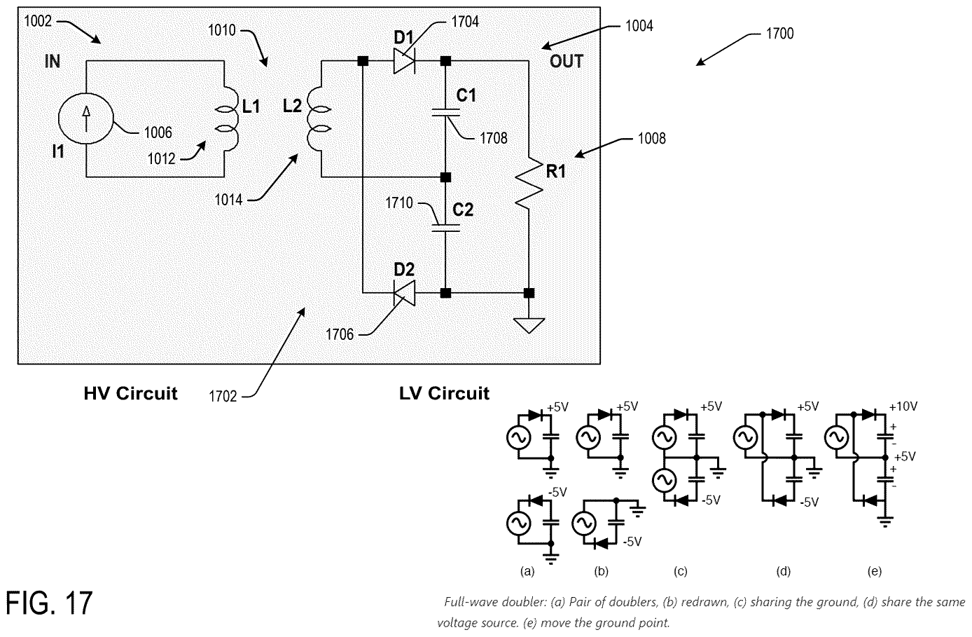

Additional circuit designs also are contemplated. For example, when using a rectifier, as in some examples discussed above, the peak output voltage may be limited by the peak of the input voltage. In some examples, a higher output voltage can be achieved using a full-wave voltage multiplier. For example, FIG. 17 shows a transformer circuit 1700. In FIG. 17, reference numerals introduced in the discussion of FIG. 10 are used to designate the same components, e.g., including the primary circuit 1002 and the secondary circuit 1004. The circuit 1700 includes a full-wave voltage doubler 1702 including a first diode 1704, a second diode 1706, a first capacitor 1708, and a second capacitor 1710. More specifically, the first diode 1704 and the first capacitor 1708 comprise a first half-wave multiplier and the second diode 1706 and the second capacitor 1710 comprise a second half-wave multiplier. The sequence 1712 included in FIG. 17 illustrates a derivation of the full-wave voltage doubler from two half-wave multipliers. In more detail, in the example of FIG. 17, the first capacitor 1708 may be charged to +Vpeak during a positive cycle and the second capacitor 1710 may be charged to −Vpeak during the negative cycle. Measuring the voltage across both capacitors 1708, 1710 provides a full peak-to-peak voltage difference (e.g., twice Vpeak) instead of just one cycle peak (Vpeak).

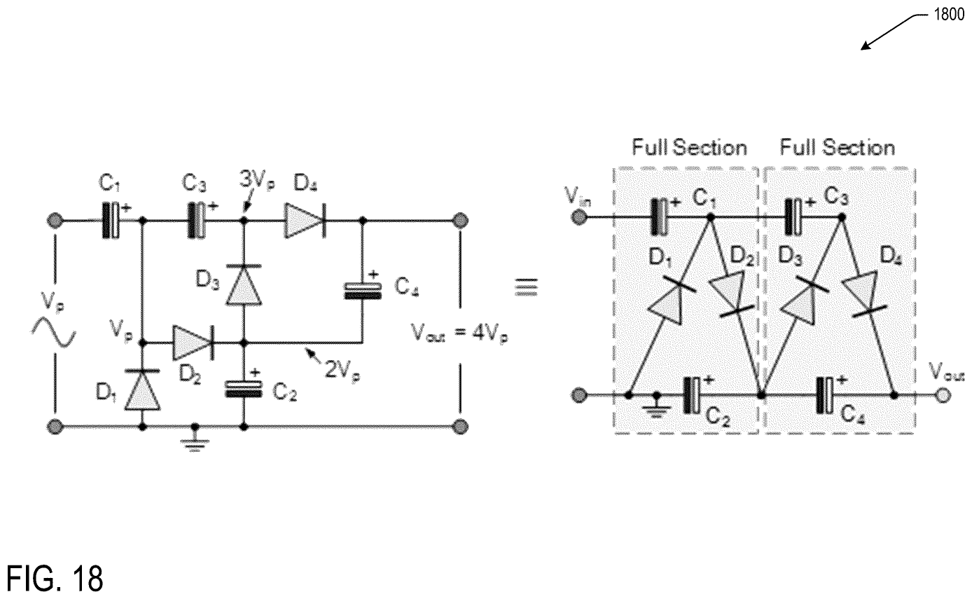

FIG. 17 shows a full-wave voltage doubler, but in other implementations the input voltage may be further multiplied (theoretically indefinitely) through the use of more capacitor/diode pairs. In practice, the multiplication may be limited by the amount of current that can be supplied at the multiplied voltage. For instance, FIG. 18 illustrates an example circuit 1800 including a voltage “quadrupler,” e.g., which multiplies the input voltage four times. FIG. 18 also demonstrates that the voltage may be further multiplied by adding additional “full sections” in series. As will be appreciated, placing these multipliers between the secondary inductor 1014 and the resistor (load) 1008, e.g., the pyro device, may result in additional advantages, e.g., based on the multiplied output voltage.

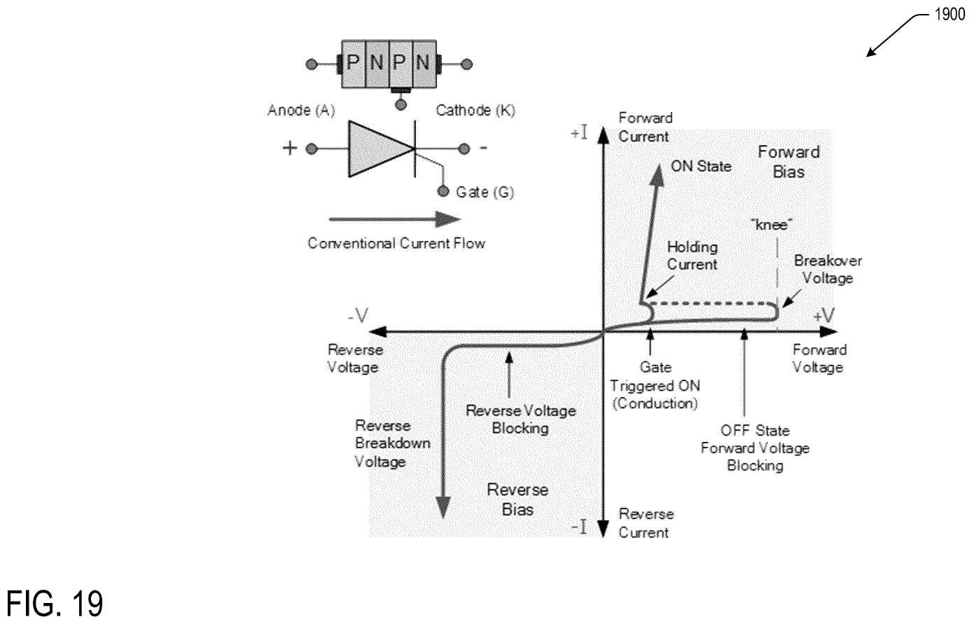

Additional circuit designs also are contemplated. For example, some aspects of this disclosure can include logic gates. One example of a logic gate is a silicon controlled rectifier (SCR) or thyristor. The SCR is a passive component that blocks current in both directions until a gate of the SCR is exposed to a trigger current. When introduced to the trigger current, the SCR switches into forward conduction, like a diode, until the current falls below a specified threshold. FIG. 19 includes a graphic 1900 showing aspects of SCRs.

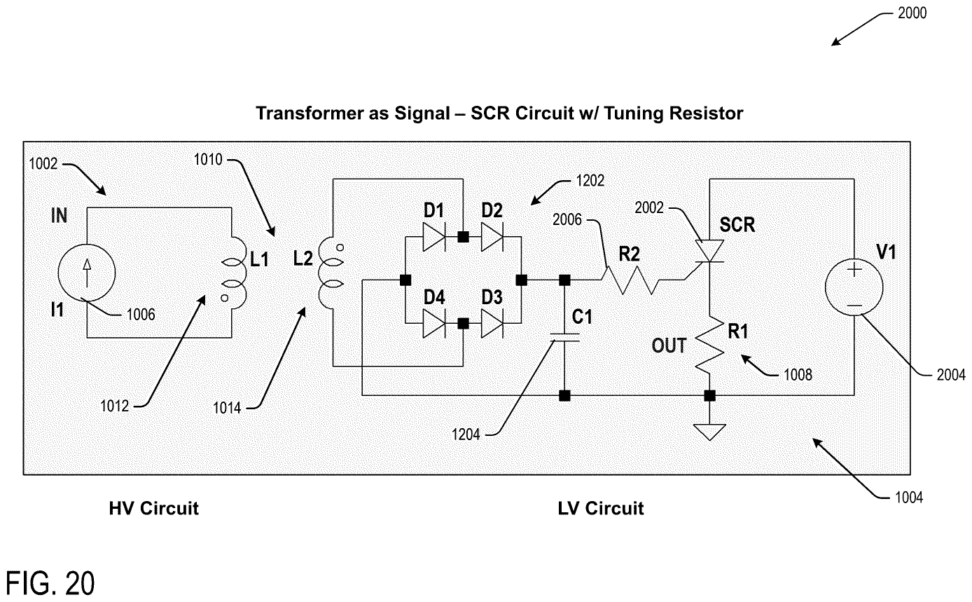

FIG. 20 shows an example transformer circuit 2000 that includes an SCR circuit. In FIG. 20, reference numerals introduced in the discussion of FIGS. 10-19 are used to designate the same components, e.g., including the primary circuit 1002 and the secondary circuit 1004. In more detail, the transformer circuit 2000 includes a rectifier circuit, e.g., including the diode bridge 1202 and the optional smoothing capacitor 1204. An SCR 2002 is disposed between the secondary inductor 1014 and the resistor (load) 1008, e.g., the pyro device. In this example, the transformer, e.g., the inductor pair 1010 acts like a current sensor only that provides the necessary trigger-current to the SCR 2002 at a specified DI/DT. As illustrated in FIG. 20, the circuit 2000 can also include a secondary voltage source 2004, that is connected to the pyro device when the SCR 2002 is triggered. The transformer circuit 2000 can also include a tuning resistor 2006, which may allow for adjustment of the trigger current associated with the SCR 2002.

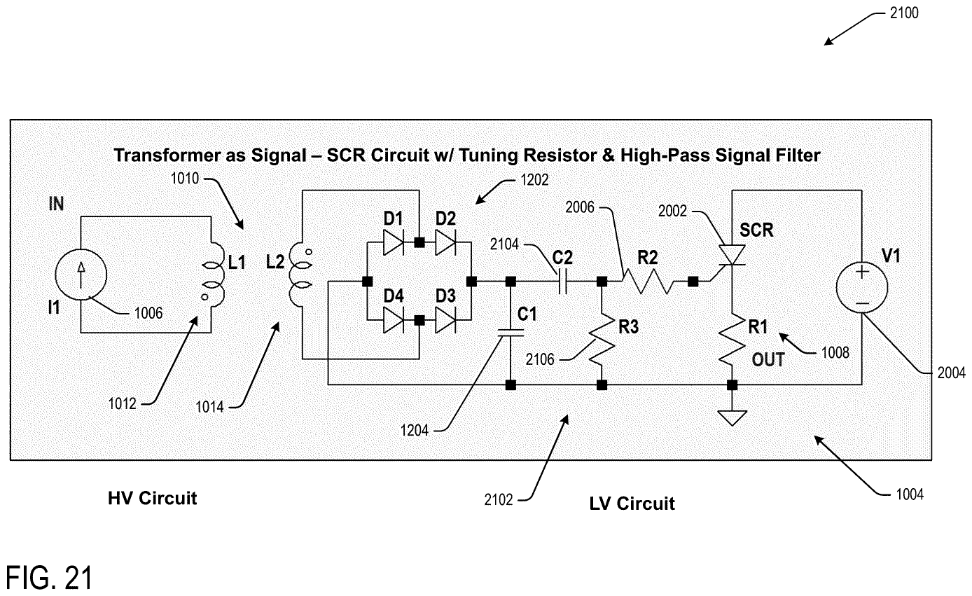

Modifications to the foregoing also are contemplated. For example, and without limitation, FIG. 21 illustrates another transformer circuit 2100 that includes an SCR circuit and a filtering circuit. In FIG. 21, reference numerals introduced in the discussion of FIGS. 10-20 are used to designate the same components, e.g., including the primary circuit 1002 and the secondary circuit 1004. The transformer circuit 2100 may be substantially the same as the transformer circuit 2000, with addition of a high-pass signal filter 2102 between the rectifier circuit 1202, 1204 and the SCR 2002. In the example of FIG. 21, the filter 2102 is configured as an RC pair, e.g., including a capacitor 2104 and a resistor 2106. In examples, adding the RC pair before the tuning resistor 2006 can protect the gate from noise.

In the examples of FIGS. 19, 20, and 21 the SCR 2002 is used as an example of a passive component. Other passive components also are contemplated. Moreover, in some examples the SCR 2002 can be replaced with (or supplemented by) one or more active logic components.

Additional modifications to the foregoing also are contemplated. For instance, although the transformer circuits 2000, 2100 are illustrated as including the SCR 2002 and a separate voltage source 2004, other example circuits may not require the separate power source 2004. For instance, the transformer may be used to supply both the SCR and pyro trigger currents.

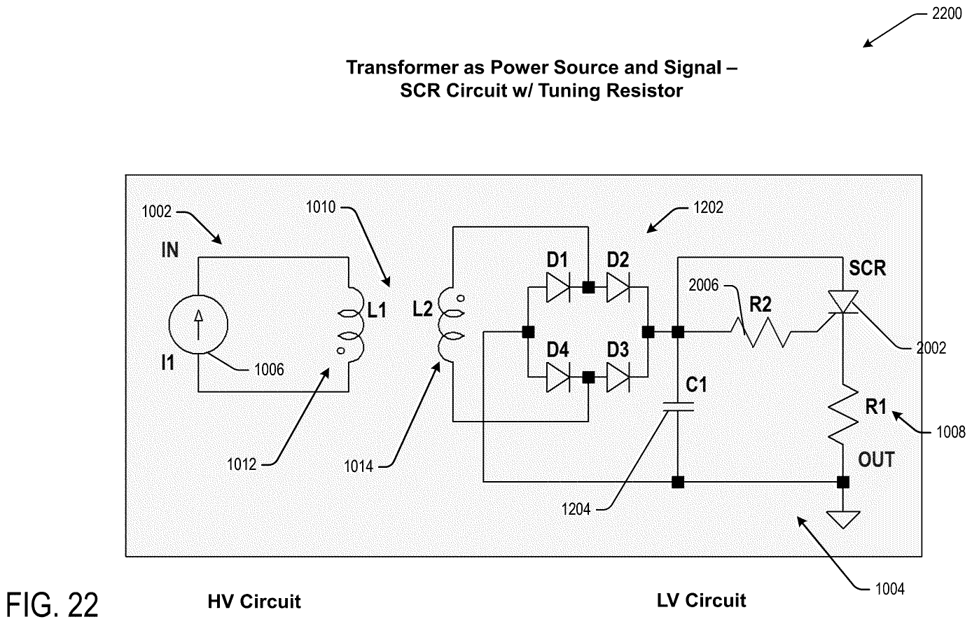

FIG. 22 shows an alternative example transformer circuit 2200. In FIG. 22, reference numerals introduced in the discussion of FIGS. 10-21 are used to designate the same components, e.g., including the primary circuit 1002 and the secondary circuit 1004. In the circuit 2200, the SCR 2002 and the resistor (load) 1008 (e.g., the pyro device) are powered by the transformer. More specifically, during normal operation, the transformer charges the smoothing capacitor 1204 and sends a small signal to the SCR 2002. During a short-circuit event, the transformer produces enough power to switch the SCR 2002 into its conduction state. In the conduction state, both the transformer 1010 and the capacitor 1204 are connected to the pyro device, e.g., to power the pyro device 1008.

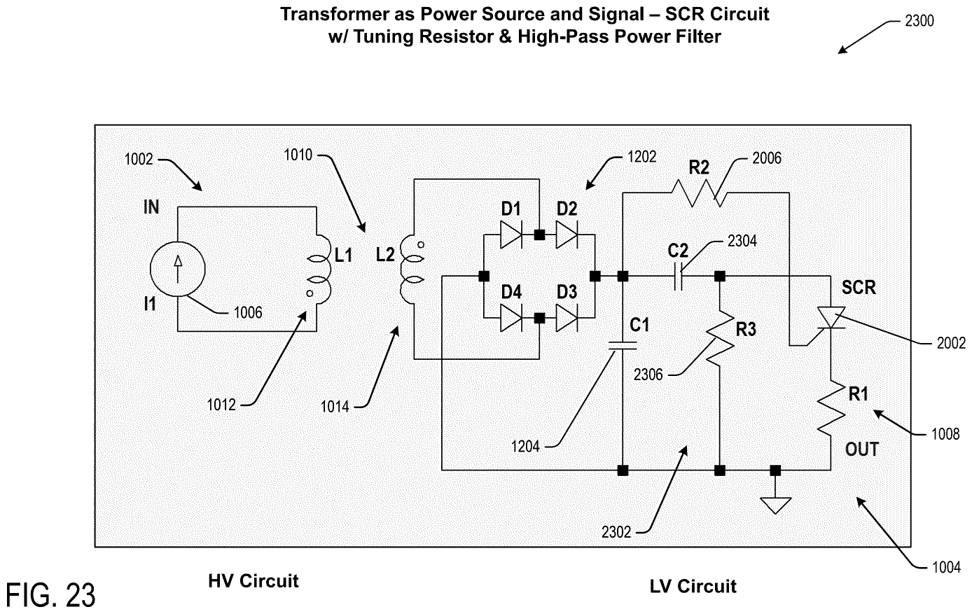

FIG. 23 shown an example transformer circuit 2300 similar to the transformer circuit 2200, with addition of a high-pass signal filter 2302. In FIG. 23, reference numerals introduced in the discussion of FIGS. 10-22 are used to designate the same components, e.g., including the primary circuit 1002 and the secondary circuit 1004. In the example of FIG. 23, the filter 2302 is configured as an RC pair, e.g., including a capacitor 2304 and a resistor 2306. In examples, adding the RC pair before the SCR's gate or anode can provide additional filtering, although the SCR 2002 may protect the pyro device 1008 from noise during normal operation. Although the example of FIG. 23 shows an RC filter, other filters, e.g., Zener diodes, can also or alternatively be used for additional filtering.

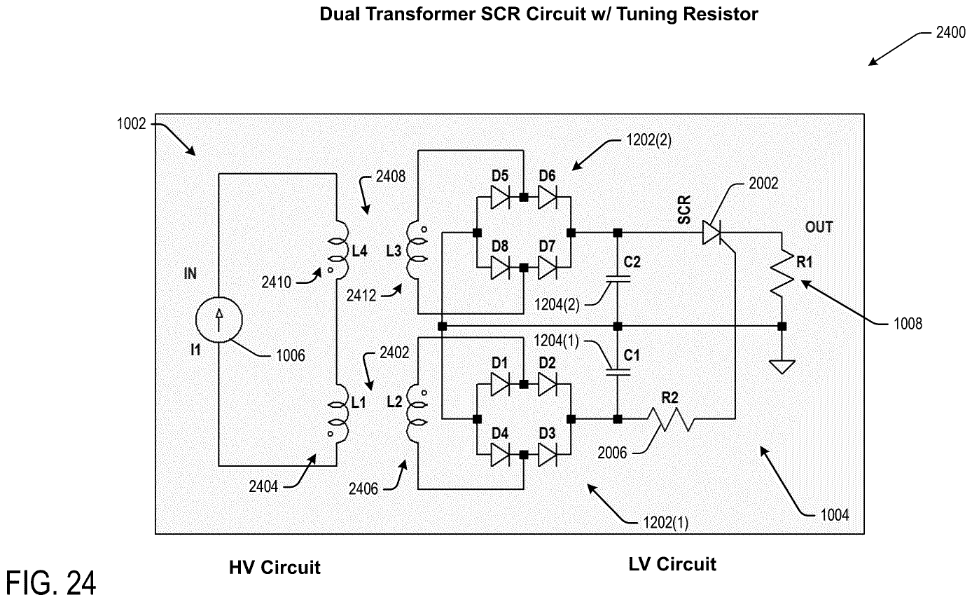

Additional circuit designs also are contemplated. For example, FIG. 24 shows an example dual transformer circuit 2400. In FIG. 24, reference numerals introduced in the discussion of FIGS. 10-23 are used to designate the same components, e.g., including the primary circuit 1002 and the secondary circuit 1004. As illustrated, the dual transformer circuit 2400 includes two transformers or inductor pairs, e.g., a first inductor pair 2402 including a first inductor 2404 and a second inductor 2406 and a second inductor pair 2408 including a third inductor 2410 and a fourth inductor 2412. For example, the first inductor pair 2402 and/or the second inductor pair 2408 may correspond to the inductor pair 1010 discussed above. In the example, an SCR trigger current and the resistor (load) 1008, e.g., the pyro device as the interrupter, trigger current/voltage can be supplied by different transformers. Such an arrangement may allow for greater tunability, for example. In the example of FIG. 24, a transformer-rectifier pair (generally like that shown in earlier examples of this disclosure, including FIG. 12) is provided for each of the trigger currents. According to this arrangement, the input from the gate and the anode of the SCR 2002 can be tuned independently.

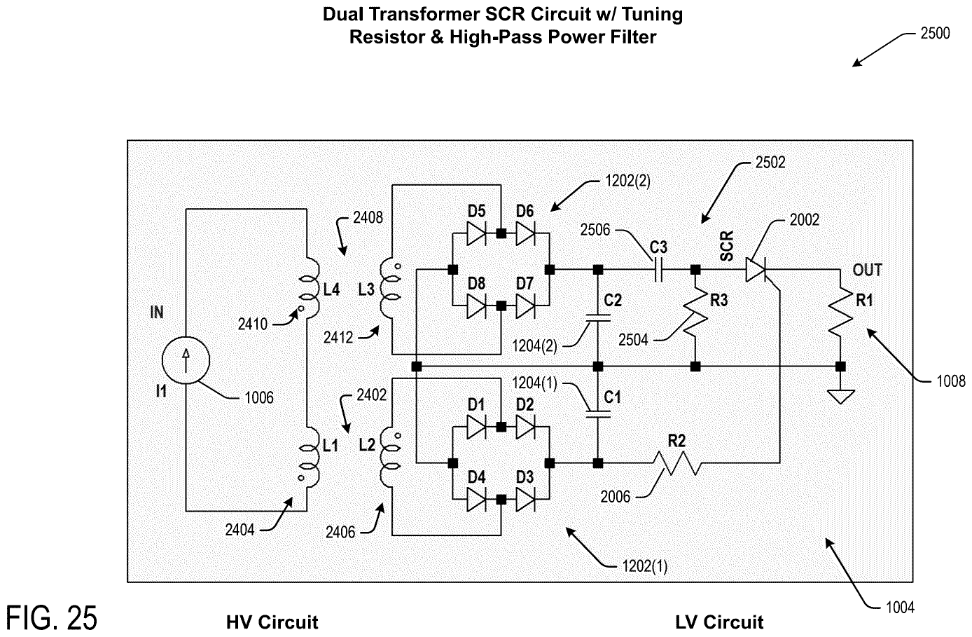

FIG. 25 shows another example of a dual transformer circuit 2500. In FIG. 25, reference numerals introduced in the discussion of FIGS. 10-24 are used to designate the same components, e.g., including the primary circuit 1002 and the secondary circuit 1004. The dual transformer circuit 2500 is similar to the dual transformer circuit 2400, but includes a filtering component, illustrated in FIG. 25 as an RC pair 2502 including a resistor 2504 and a capacitor 2506. The RC pair 2502 is an example filter than may be placed directly before the gate or anode of the SCR 2002 to provide additional filtering. The RC pair 2502 is for example only; other filtering arrangements, including, but not limited to Zener diodes or the like, also are contemplated.

In still further implementations of this disclosure, some example transformer circuits may be configured such that the transformer or induction pair is dedicated to power generation. In such examples, the transformer circuit may further include a secondary switch. The switch may be active or passive.

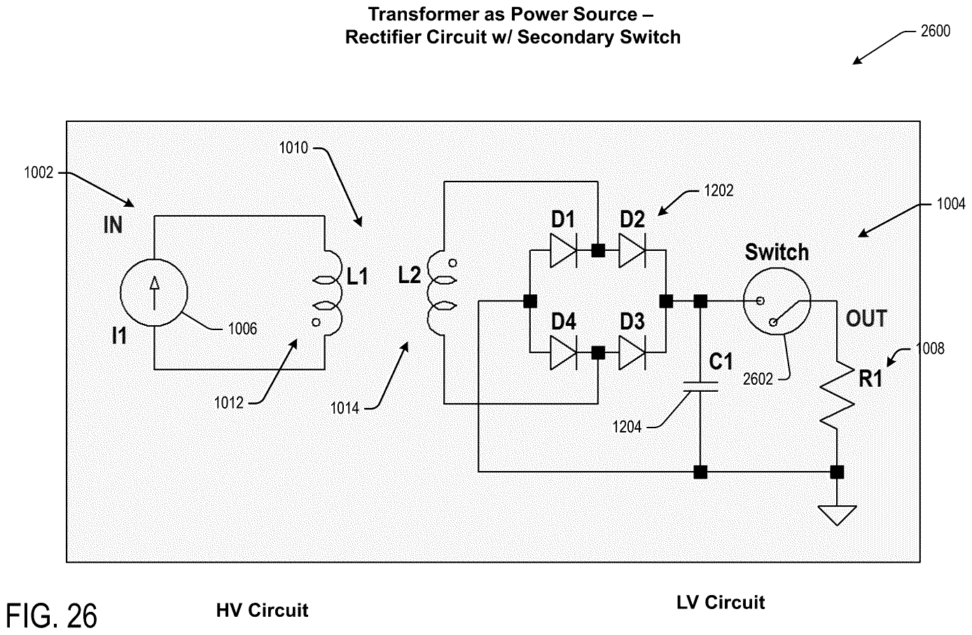

FIG. 26 is an example of a transformer circuit 2600 that uses the transformer as a power source, and incorporates a switch 2602. In FIG. 26, reference numerals introduced in the discussion of FIGS. 10-25 are used to designate the same components, e.g., including the primary circuit 1002 and the secondary circuit 1004. For instance, the transformer circuit 2600 may be a power rectifier circuit, e.g., as in FIG. 12. More specifically, the secondary circuit 1004 includes the diode bridge 1202 and the capacitor 1204. During normal operation of the transformer circuit 2600, the transformer is dedicated to charging a capacitor, e.g., the capacitor 1204. The switch 2602 of the transformer circuit 2600 will selectively (e.g., during a short circuit or other event) connect the transformer (e.g., via the capacitor 1204) to the resistor (load) 1008, e.g., the circuit interrupting device. When the switch is an active switch, the point at which the switch will connect the capacitor to the resistor (load) 1008 may be predetermined, e.g., via user selection. When the switch is a passive switch, the switch may connect the capacitor to the resistor (load) 1008 when enough current passes through the primary circuit 1002. For example, the switch may be a reed switch coupled to the primary circuit's 1002 magnetic field.

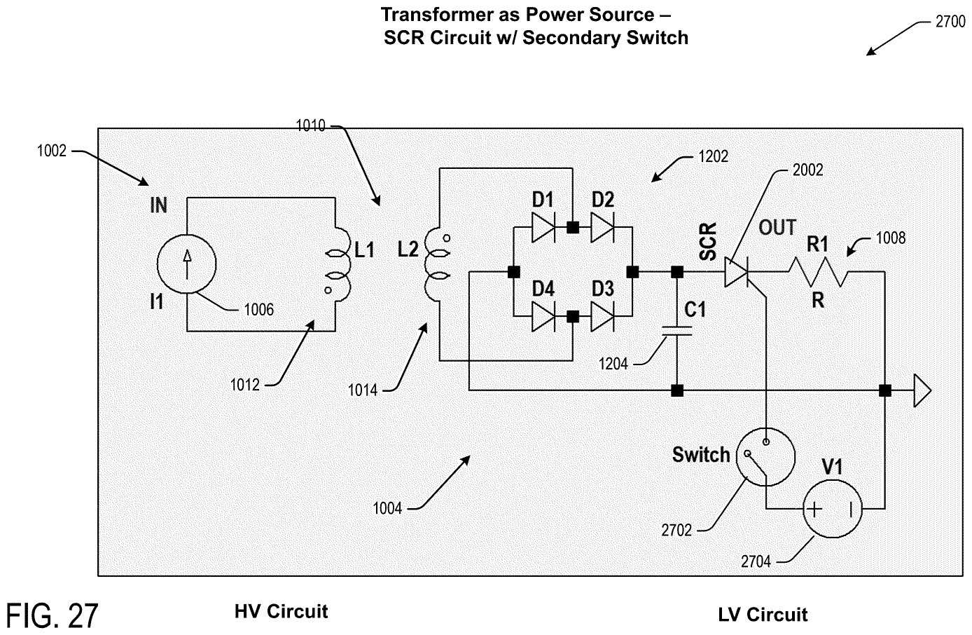

FIG. 27 shows another example transformer circuit 2700 in which the transformer is again used to charge a capacitor 1204 during normal operation, but that also includes an SCR 2002. In FIG. 27, reference numerals introduced in the discussion of FIGS. 10-26 are used to designate the same components, e.g., including the primary circuit 1002 and the secondary circuit 1004. The transformer circuit 2700 may be an active logic circuit. In this example, the trigger current of the SCR 2002 may be controlled by a switch 2702. For example, in the case of an active switch, the trigger current can be controlled directly. When the switch is a passive switch, the switch may generate its own power or may otherwise be connected to a power supply 2704, e.g., as shown in FIG. 27. Although the SCR 2002 is shown in the example of FIG. 27, other active logic components may be used in place of, or in addition to, the SCR 2002. Such components can include one or more Op-amps, microcontrollers, or the like.

As will be appreciated from the foregoing, aspects of the current disclosure provide a sensing mechanism for current interrupting devices like fuses that magnetically couples a primary circuit with a secondary circuit contained within the device in a manner that induces a voltage that is then used to passively trigger current interruption functionality of said device at a specified level. In examples, the present invention enables passive trigger functionality without the shortcomings of traditional thermal fuses. Moreover, the functionality may be achieved without moving parts, electronic sensors, or integrated circuits such as those found in existing high performance current interruption devices. The systems and techniques provided herein may provide lower electrical resistance, higher interruption speed, lower cost, and/or higher reliability.

Aspects of this disclosure also provide for improved circuit designs for use with transformer arrangements like those presented herein. For instance, the circuit designs detailed herein may include intermediate circuits and/or circuit elements, e.g., disposed between a transformer and a load, like a pyrotechnic device. The circuit designs detailed herein can provide extra functionality including but not limited to prevention of pyro-aging via signal filtering and/or signal blocking and greater tunability and/or flexibility of the transformer-pyro circuit. In some examples, the circuit designs detailed herein can provide for: one or more transformers as a power source, one or more transformers as a trigger signal source, and/or one or more transformers as both a power and signal source. Also in examples, one or more of the circuit designs detailed herein may decouple the tuning of the trigger and power signals from one another and/or may decouple the tuning of the trigger and power signals from physical components of the transformer. In aspects of this disclosure some or all of the above functionalities may be achieved by inclusion of one or more of filtering circuits (e.g., RC circuits), half- or full-wave rectifiers, e.g., as voltage multipliers, Zener diodes, passive logic-gate circuits, including but not limited to SCR circuits, active logic-gate circuits, including but not limited to Op-Amp or microprocessor circuits, passive switching devices, including but not limited to reed switches, active switching devices, including but not limited to op-amps or microprocessors, and/or external power sources, such as batteries.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A circuit interruption system for use with a first circuit conveying a current from a power source to a load, the circuit interruption system comprising:
a second circuit disposed in a magnetic field generated by the current passing through the first circuit, wherein the magnetic field induces an induced voltage in the second circuit; and
a circuit interrupting device configured to open the first circuit in response to a change in the induced voltage caused by a change in the magnetic field.

2. The circuit interruption system of claim 1, further comprising:
a coil associated with the second circuit and disposed at least partially in the magnetic field.

3. The circuit interruption system of claim 2, further comprising an insulator disposed between the first circuit and the coil.

4. The circuit interruption system of claim 2, further comprising:
a ferromagnetic core disposed to, at least in part, direct a magnetic flux associated with the magnetic field,
wherein the coil is disposed about the ferromagnetic core.

5. The circuit interruption system of claim 4, wherein the ferromagnetic core circumscribes a portion of the first circuit.

6. The circuit interruption system of claim 5, wherein the coil is disposed on the ferromagnetic core such that the coil circumscribes the portion of the first circuit.

7. The circuit interruption system of any one of claim 1 through claim 6, wherein the circuit interrupting device comprises a pyrotechnic device.

8. The circuit interruption system of any one of claim 1 through claim 7, wherein the second circuit comprises at least one intermediate member between the coil and a load associated with the circuit interrupting device.

9. The circuit interruption system of claim 8, wherein the at least one intermediate member comprises at least one of a filtering circuit, a rectifier, a smoothing capacitor, a Zener diode, a voltage multiplier, a logic gate circuit, a silicon controller rectifier, a supplemental power source, a switch, an op-amp, or a microcontroller.

10. A system comprising:
a first circuit for conveying a current from a power source to a load;
a second circuit comprising a coil disposed in a magnetic field generated by the current passing through the first circuit, wherein the magnetic field induces an induced voltage in the second circuit proximate the coil; and
a circuit interrupting device configured to open the first circuit in response to a change in the induced voltage caused by a change in the magnetic field.

11. The system of claim 10, wherein the second circuit further comprises:
a ferromagnetic core disposed to, at least in part, direct a magnetic flux associated with the magnetic field,
wherein the coil is disposed about the ferromagnetic core.

12. The system of claim 11, wherein the ferromagnetic core circumscribes a portion of the first circuit.

13. The system of claim 12, wherein the coil is disposed on the ferromagnetic core such that the coil circumscribes the portion of the first circuit.

14. The system of claim 12, wherein the second circuit comprises at least one intermediate member between the coil and the circuit interrupting device.

15. The system of claim 14, wherein the at least one intermediate member comprises at least one of a filtering circuit, a rectifier, a smoothing capacitor, a Zener diode, a voltage multiplier, a logic gate circuit, a silicon controller rectifier, a supplemental power source, a switch, an op-amp, or a microcontroller.
